(19) United States
(12) Patent Application Publication
(10) Pub. No.: US 2025/0365332 A1
(43) Pub. Date: Nov. 27, 2025

(54) INFORMATION PROCESSING APPARATUS, IMAGE PICKUP APPARATUS, INFORMATION PROCESSING METHOD, AND STORAGE MEDIUM

(71) Applicant: CANON KABUSHIKI KAISHA, Tokyo (JP)

(72) Inventor: YOSHIYUKI TAKI, Tochigi (JP)

(21) Appl. No.: 19/297,961

(22) Filed: Aug. 12, 2025

Related U.S. Application Data
(63) Continuation of application No. PCT/JP2024/001215, filed on Jan. 18, 2024.

(30) Foreign Application Priority Data
Feb. 14, 2023 (JP) 2023-020486

(51) Int. Cl. H04L 65/611; H04L 65/75

(52) U.S. Cl. CPC H04L 65/611; H04L 65/764

(57) ABSTRACT

An information processing apparatus that is used when distribution data generated by an image pickup apparatus is distributed via a distribution server of a network distribution service includes one or more memories storing instructions, and one or more processors that, upon execution of the instructions, operate to acquire first information for registering the image pickup apparatus and second information for registering distribution of the distribution data, register the image pickup apparatus in association with the distribution, transmit the second information to the distribution server, receive third information for executing the distribution created by the distribution server based on the second information, and transmit the third information to the image pickup apparatus registered in association with the distribution executed using the third information. The second information includes a date and time of the distribution.

### CROSS-REFERENCE TO RELATED APPLICATIONS

This application is a Continuation of International Patent Application No. PCT/JP2024/001215, filed on Jan. 18, 2024, which claims the benefit of Japanese Patent Applications No. 2023-020486, filed on Feb. 14, 2023, each of which is hereby incorporated by reference herein in their entirety.

### BACKGROUND

### Field of the Technology

The present disclosure relates to an information processing technology for

distributing content using a network distribution service.

### Description of the Related Art

As a service for distributing content to a user via a network, there is a distribution service (such as a cloud service) which allows the user to livestream content such as moving image data captured by a digital camera to other users via the Internet. Japanese Patent Application Laid-Open No. 2015-220595 discloses a system in which a digital camera and a server communicate with each other, and the server livestreams moving image data captured by the digital camera. In such a system, there is a demand for enabling the user to distribute moving image data directly from the camera onto the Internet without using a personal computer (PC).

In order to livestream moving image data directly from the camera, the settings of the distribution service may be set on the camera. However, the operation of setting the information for livestreaming, such as a distribution URL and a stream key, on the camera without using a PC is arduous for the user.

### SUMMARY

An information processing apparatus according to one aspect of the present disclosure that is used when distribution data generated by an image pickup apparatus is distributed via a distribution server of a network distribution service includes one or more memories storing instructions, and one or more processors that, upon execution of the instructions, operate to acquire first information for registering the image pickup apparatus and second information for registering distribution of the distribution data, register the image pickup apparatus in association with the distribution, transmit the second information to the distribution server, receive third information for executing the distribution created by the distribution server based on the second information, and transmit the third information to the image pickup apparatus registered in association with the distribution executed using the third information. The second information includes a date and time of the distribution.

An image pickup apparatus according to another aspect of the present disclosure is configured to acquire the third information from the above information processing apparatus, and execute the distribution using the third information. A distribution system having the above information processing apparatus also constitutes another aspect of the present disclosure. An information processing method corresponding to the above information processing apparatus also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of a communication system according to this embodiment.

FIG. 2 illustrates the configuration of a digital camera according to this embodiment.

FIG. 3 illustrates the configuration of a relay server according to this embodiment.

FIGS. 4A and 4B illustrate, respectively, table data for registering a digital camera and table data for registering a cloud service according to this embodiment.

FIGS. 5A and 5B illustrate, respectively, processing executed by a relay server and other processing executed by the relay server according to this embodiment.

FIG. 6 illustrates processing in which a digital camera transmits distribution data to a distribution server according to this embodiment.

FIGS. 7A, 7B, and 7C illustrate a start screen, a standby screen, and a streaming screen, respectively, in livestreaming processing according to an embodiment.

FIG. 8 is a flowchart illustrating processing executed by a digital camera according to this embodiment.

FIG. 9 is a flowchart illustrating processing executed by a relay server according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Hereinafter, embodiments of the present disclosure will be described with reference to the drawings.

### System Configuration

FIG. 1 illustrates a system configuration according to this embodiment for livestreaming moving image data acquired by imaging using a portable digital camera (simply referred to as “camera” hereinafter) 100, which serves as an image pickup apparatus (and a communication apparatus). Livestreaming refers to the real-time distribution of image data, audio data, and the like from a distributor (user) to viewers (other users) via the Internet as a network, using streaming technology. The viewers can view image data, audio data, and the like in a manner similar to live TV or radio broadcasting. In this embodiment, a network distribution service which performs such livestreaming (for example, a cloud service) is referred to as a livestreaming service.

The camera 100 accesses a relay server 200 and a distribution server 300, each serving as a computer, via a network through a network router 400 which functions as a wireless Local Area Network (LAN) access point (simply referred to as “router” hereinafter). Here, it is assumed that the camera 100 stores an address for accessing the relay server 200, and the relay server 200 stores an address of the distribution server 300. The address may be an IP address, a URL, or the like.

The distribution server 300 in this embodiment provides the livestreaming service. The camera 100, as a client for the distribution server 300, joins a network (the Internet) which includes the network router 400 to connect to the relay server 200. The relay server 200 is connected to the distribution server 300 via a public line. The camera 100 receives the address of the distribution server 300 from the relay server 200 and can connect to the distribution server 300 using that address.

In this embodiment, the camera 100 is wirelessly connected to the network router 400, but the camera 100 may be connected to the network router 400 by a wired connection. Although a single camera 100 is used for this embodiment, a plurality of cameras 100 may be connected to the relay server 200 and the distribution server 300.

### Configuration of Camera 100

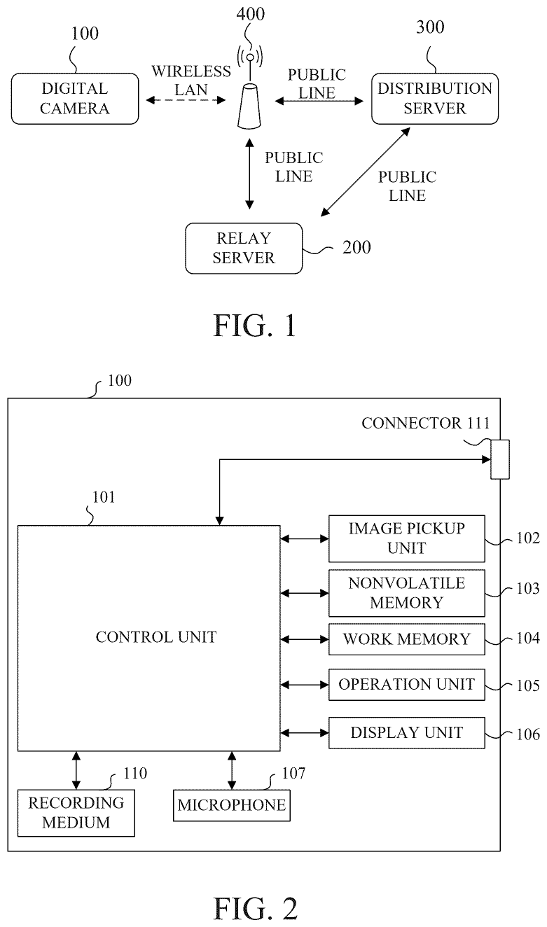

FIG. 2 illustrates the configuration of the camera 100. The camera 100 has a function for using the livestreaming service. A control unit 101 controls the entire camera 100 in accordance with input signals and a program described later. Instead of the control unit 101 controlling the entire camera 100, a plurality of pieces of hardware may share the processing to control the entire camera 100.

An imaging unit 102 includes an optical system which includes a zoom lens, a focus lens, an aperture stop, and the like, and an image sensor which converts an object image, which is formed as an optical image by the optical system, into an imaging signal as an electrical signal. As the image sensor, a Complementary Metal Oxide Semiconductor (CMOS) sensor or a Charge Coupled Device (CCD) sensor is used. The imaging signal from the imaging unit 102 is input to the control unit 101. The control unit 101 performs various image processing operations, such as noise reduction processing, on the imaging signal to generate image data. The image data herein mainly refers to moving image data but also includes still image data. In this embodiment, the processing of acquiring moving image data through the imaging unit 102 is referred to as “imaging.” The control unit 101 records the generated image data in a recording medium 110 in accordance with the Design Rule for Camera File system (DCF) standard. The control unit 101 also temporarily records the image data for distribution in livestreaming in a working memory 104.

A nonvolatile memory 103 is a nonvolatile memory which is electrically erasable

and recordable and stores programs and the like executed by the control unit 101. The working memory 104 is used as a buffer memory which temporarily holds image data generated by the imaging unit 102, as a memory which stores image data to be displayed on a display unit 106 described later, and as a work area and the like of the control unit 101.

An operation unit 105 is operated by a user to receive input of instructions for the camera 100. The operation unit 105 includes operation members such as a power button for instructing turning on and off of the power of the camera 100, a release switch for instructing imaging, and a playback button for instructing playback of stored image data. When the release switch is pressed halfway, SW1 is turned on, and the control unit 101 starts imaging preparation operations such as autofocus (AF) processing, auto-exposure (AE) processing, and auto white balance (AWB) processing. When the release switch is fully pressed, SW2 is turned on, and the control unit 101 starts an imaging operation.

The operation unit 105 also includes a dedicated connection button for starting communication with an external device via a connector 111, which will be described later. A touch panel provided in a display unit 106 is also included in the operation unit 105.

The display unit 106 displays viewfinder image data which is generated before imaging of recording image data and the recording image data, and displays characters and symbols to facilitate user operation. The display unit 106 employs a liquid crystal display, an organic EL display, or the like. The display unit 106 is not necessarily required to be included in the camera 100, and may be provided as an external device separate from the camera 100. Even in this case, the control unit 101 has a function of controlling the display of the display unit 106. The control unit 101 also causes the display unit 106 to function as an electronic viewfinder by sequentially transferring image data stored in the working memory 104 to the display unit 106 and displaying it as a live-view image.

A microphone 107 converts sound into an electrical signal and inputs it to the camera 100. The control unit 101 generates audio data from the input electrical signal and records the audio data in synchronization with image data generated by the imaging unit 102. In this embodiment, the audio data for livestreaming is recorded in the working memory 104. The microphone 107 may be built into the camera 100 or may be detachably attached to the camera 100.

The recording medium 110 is a semiconductor memory, an optical disc, or the like which is capable of recording image data output from the imaging unit 102. The recording medium 110 may be built into the camera 100 or may be detachably attachable to the camera 100.

The connector 111 is a communication interface which connects to various external devices. The control unit 101 performs communication with various external devices by controlling the connector 111. The camera 100 can exchange image data and audio data with the relay server 200 and the distribution server 300 via the connector 111. The connector 111 includes an interface which performs communication by wireless LAN in accordance with the IEEE802.11 standard. The connector 111 also has a client mode which operates as a client in an infrastructure mode. By operating the connector 111 in the client mode, the camera 100 can operate as a client device in the infrastructure mode.

In a case where the camera 100 operates as a client device, it can join a LAN including an access point by connecting to a nearby access point. A communication method of the connector 111 is not limited to wireless LAN, and includes public wireless communication methods such as 4G and LTE, and wired communication methods in accordance with standards such as Ethernet.

### Configuration of Relay Server 200

FIG. 3 illustrates a configuration of the relay server 200 as an information processing apparatus. Instead of the relay server 200, another device which functions as an information processing apparatus and which has a function of relaying communication between the camera 100 and the distribution server 300 and storing a plurality of pieces of event information, which will be described later and received from the distribution server 300, may be used. Such another device includes a smartphone, a tablet device, and a personal computer (PC), and the like.

A control unit (one or more processors) 201 controls the entire relay server 200 in accordance with input signals and programs. The control unit 201 in this embodiment corresponds to a registration unit and a control unit. Instead of the control unit 201 controlling the entire relay server 200, a plurality of pieces of hardware may share the processing to control the entire relay server 200.

A nonvolatile memory 203 is a nonvolatile memory which is electrically erasable and recordable. The nonvolatile memory 203 stores an operating system (OS), which is basic software executed by the control unit 201, and applications which cooperate with the OS to implement various functions. The applications include an application for communicating with the camera 100 and the distribution server 300. Furthermore, a database, which will be described later, is also stored in the nonvolatile memory 203.

A working memory 204 is a volatile memory which is used as a work area of the control unit 201 and as a save area for data in error processing and the like.

An operation unit 205 is operated by a user to receive input of instructions for the relay server 200. The operation unit 205 includes a power button for instructing turning on and off of the relay server 200, and input devices such as a keyboard and a mouse. The operation unit 205 also includes a touch panel provided in a display unit 206, which will be described later. The operation unit 205 does not necessarily need to be built into the relay server 200, and an external operation unit 205 may be connected to the relay server 200.

The display unit 206 displays characters and symbols to facilitate user operation. The display unit 206 employs a liquid crystal display, an organic EL display, or the like. The display unit 206 is not necessarily required to be included in the relay server 200, and may be provided as an external device separate from the relay server 200. Even in this case, the control unit 201 has a function of controlling the display of the display unit 206.

An external recording device 210 reads and writes data to an external recording medium. In a case where a program or image data is recorded in the external recording medium, the program or image data is read into the working memory 204 via the external recording device 210. As the external recording medium, an optical disc, a flexible disc, a magnetic disk, a semiconductor memory, and the like are used.

A connector 211 is a communication interface for connecting to various external devices. The control unit 201 performs communication with various external devices by controlling the connector 211. The relay server 200 can exchange image data and audio data with the camera 100 and the distribution server 300 via the connector 211.

### Livestreaming Service

The distribution server 300 which provides the livestreaming service is a server which mediates between a distributor and a viewer. For example, the camera 100 transmits, in real time, image data generated by imaging to the distribution server 300. The distribution server 300 provides the received image data via a web page or the like so that a viewer can view it in real time. In the following description, image data, audio data, text data, and other content data distributed to viewers in livestreaming are collectively referred to as distribution data. The camera 100 transmits to the distribution server 300 at least one of the distribution data among image data and audio data.

Before starting the livestreaming, a user creates an event on the relay server 200 through a communication apparatus such as a PC, a smartphone, or a tablet device, or through the camera 100. The event is data which includes settings related to the livestreaming, such as a title of the livestreaming, a start time of the livestreaming, and a bit rate of moving image data. The digital camera 100 can also create the event.

The distribution server 300 issues a distribution URL and a stream key for each

of one or more events created in this manner. The distribution URL is an IP address, a URL, or the like of the distribution server 300 to which the distribution data is to be transmitted. The stream key is a code which is used for identifying a stream.

When the event is requested from the camera 100, the distribution server 300

transmits the event to the camera 100 via the relay server 200. The relay server 200 may select information, among the event, which the camera 100 requires for the livestreaming and transmit the selected information to the camera 100.

Hereinafter, processing (information processing method) executed by the relay server 200 in accordance with a program will be described.

### Registration Processing of Camera 100 and Livestreaming

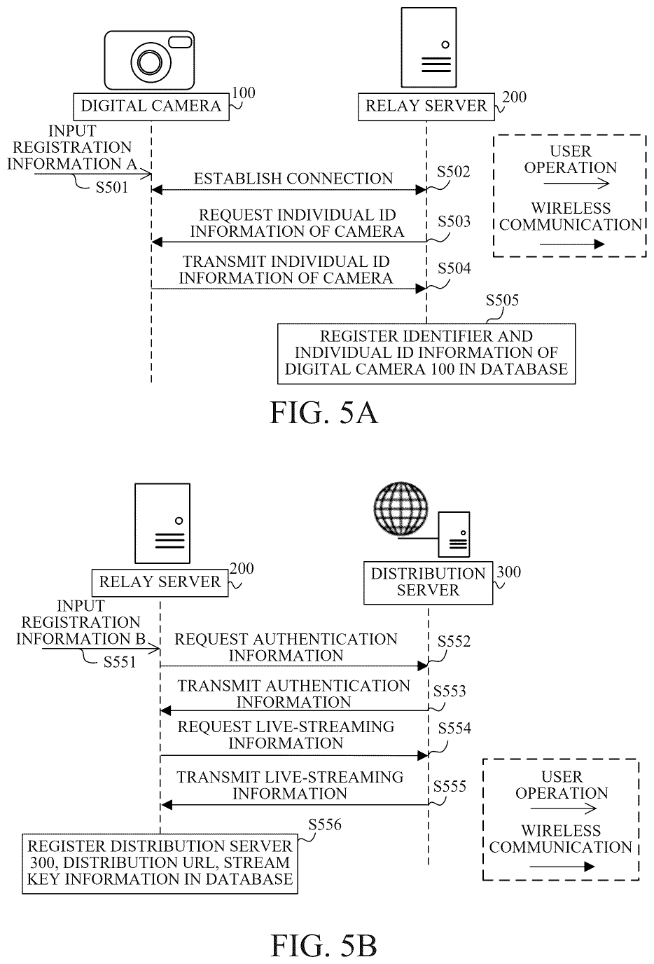

FIG. 5A illustrates processing in which the relay server 200 registers (records) the camera 100 in a database. As preparation for this processing, the camera 100, the relay server 200, and the distribution server 300 communicate with one another in compliance with HTTP.

First, in step S501, the camera 100 receives (or accepts) input of registration information (hereinafter referred to as registration information A) by a user for allowing the camera 100 to access the relay server 200. At this time, the user inputs the registration information A by touching a keyboard displayed on the display unit 106 which is provided with a touch panel. The registration information A is information which proves that the user is registered in the relay server 200, and includes an account ID as user ID information and a password for accessing the relay server 200.

Next, in step S502, the camera 100 establishes a connection with the relay server 200. At this time, the camera 100 accesses the relay server 200 using the registration information A which was input in step S501.

Next, in step S503, the relay server 200 requests individual ID information on the camera 100 for using communication for the livestreaming. The individual ID information on the camera 100 is information which enables identification of the individual camera 100, and is, for example, a serial number (manufacturing number). The individual ID information on the camera 100 corresponds to first information used for registration of the camera 100 in the relay server 200.

Next, in step S504, the camera 100 transmits the individual ID information on the camera 100, which was requested by the relay server 200, to the relay server 200.

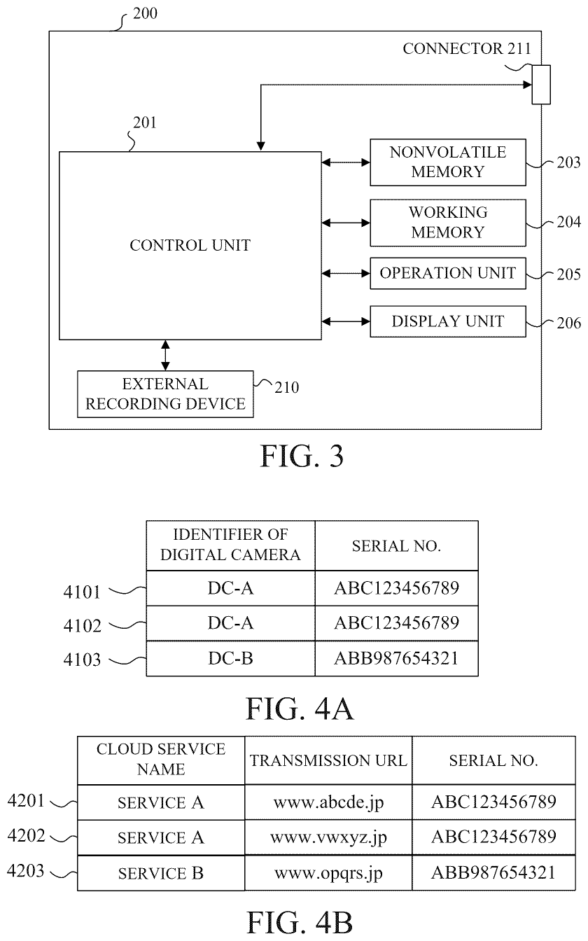

In step S505, as illustrated in FIG. 4A, the relay server 200 registers, in a database,

camera information 4101 which includes the individual ID information (e.g., ABC123456789) received from the camera 100 and an identifier of the camera 100 (e.g., DC-A). At this time, the relay server 200 generates the identifier of the camera 100. Thus, registration of the camera 100 by the relay server 200 is completed.

Although in step S501 the camera 100 transmits the registration information A, which is input by the user, to the relay server 200, the registration information A may also be transmitted to the relay server 200 by other methods, such as transmission from a communication apparatus such as a PC by the user.

In addition, in a case of registering camera information on the same camera 100 (DC-A) or another camera (DC-B) in the database illustrated in FIG. 4A, the relay server 200 requests the camera information from the camera in step S503. Then, in step S504, the camera transmits the information requested by the relay server 200 to the relay server 200. As a result, in step S505, the relay server 200 newly registers the camera information 4102 and 4103 in the database illustrated in FIG. 4A.

FIG. 5B illustrates processing in which the relay server 200 registers information on the livestreaming in a database.

First, in step S551, the relay server 200 accepts input of registration information (hereinafter referred to as registration information B) by a user, for allowing the relay server 200 to access the distribution server 300. At this time, the user inputs the registration information B into the relay server 200 via the camera 100 or a communication apparatus such as a PC or a smartphone. The registration information B is second information which is used for registration of the livestreaming using the livestreaming service, such as the date and time and title of the livestreaming.

Next, in step S552, the relay server 200 transmits the registration information B, which was input in step S551, to the distribution server 300 and requests authentication information from the distribution server 300. The authentication information is information which indicates that the livestreaming corresponding to the registration information B has been registered (that a predetermined number or more of registrants (viewers) necessary to perform the livestreaming have been registered), and is an account ID and a password for allowing the relay server 200 to access the distribution server 300. The account ID and the password may be those owned by the user, or may be those of a service provider to whom the user has requested the livestreaming.

Next, in step S553, the relay server 200 receives the authentication information from the distribution server 300. The relay server 200 accesses the distribution server 300 using the authentication information. The relay server 200 records the authentication information in association with the individual ID information on the camera 100, and, when accessing the distribution server 300, transmits the individual ID information on the camera 100 together with the authentication information.

Next, in step S554, the relay server 200 requests, from the distribution server 300, information on communication settings for the livestreaming from the distribution server 300 (referred to as livestreaming information hereinafter). The livestreaming information is information which indicates an identifier of the livestreaming, a transmission URL of distribution data, a stream key, an access token, and a communication protocol used by the distribution server 300.

Next, in step S555, the distribution server 300 transmits the livestreaming information, which was requested by the relay server 200, to the relay server 200.

Next, in step S556, the relay server 200 registers, in the database, event information 4201, in which the livestreaming information received in step S555 and the distribution server 300 (cloud service name: Service A) are associated with the individual ID information on the camera 100, as illustrated in FIG. 4B.

In addition, in a case of registering different livestreaming information on the same distribution server 300 (Service A), or livestreaming information on another distribution server (Service B), in the database illustrated in FIG. 4B, the relay server 200 requests the livestreaming information from the distribution server in step S554. Then, in steps S555 and S556, the relay server 200, having received the livestreaming information from the distribution server, registers, in the database, event information 4202 and 4203, which include the received livestreaming information, a cloud service name, and individual ID information on the camera, as illustrated in FIG. 4B.

In a case where the relay server 200 cannot receive information on a communication protocol used for the livestreaming from the distribution server 300, an administrator of the relay server 200 or the like inputs, into the relay server 200, information on the communication protocol used by the distribution server 300.

The relay server 200 may also receive the authentication information from the camera 100. In this case, the relay server 200 does not execute the processing of steps S552 and S553.

### Livestreaming Processing

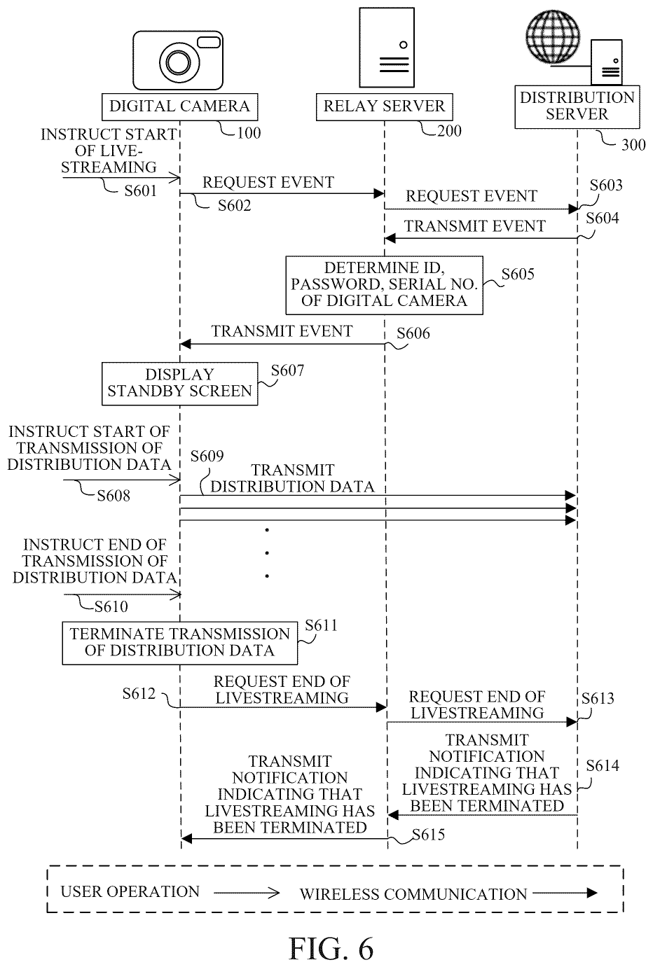

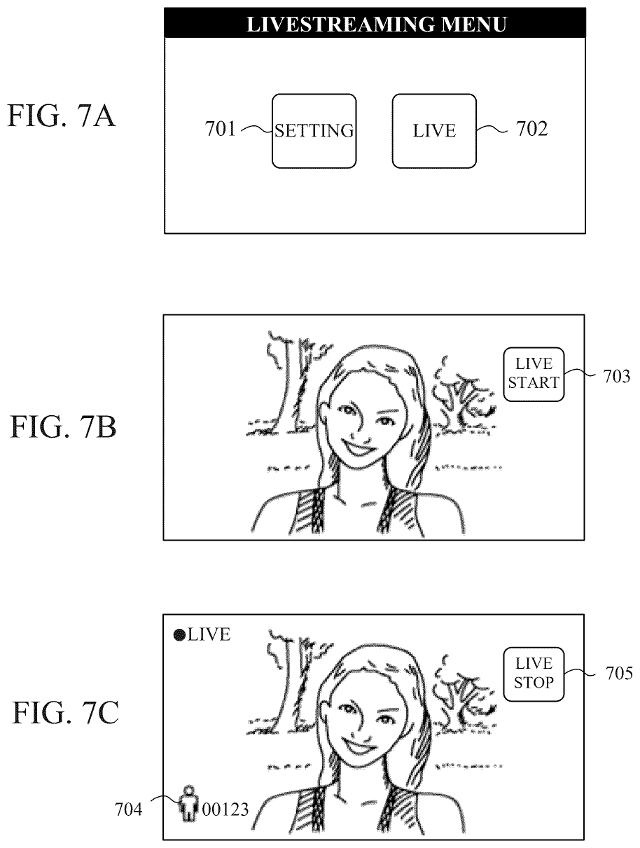

FIG. 6 illustrates livestreaming processing in this embodiment. FIGS. 7A to 7C illustrate examples of screens displayed on the display unit 106 of the camera 100 in this embodiment. Here, the livestreaming processing in a case where the camera 100 directly transmits distribution data to the distribution server 300 will be described.

In FIG. 6, steps S601 to S607 illustrate processing in which the camera 100 receives an event from the distribution server 300 via the relay server 200. First, in step S601, the camera 100 accepts input of a livestreaming instruction by a user through a touch operation of a Live switch 702 on a selection screen illustrated in FIG. 7A. When a Setting switch 701 in FIG. 7A is touched, the camera 100 starts processing for registering the camera 100 in the relay server 200, as illustrated in FIG. 5A.

Next, in step S602, the camera 100 requests, from the relay server 200, the event as third information for executing the livestreaming.

Next, in step S603, the relay server 200 requests, from the distribution server 300, the event requested by the camera 100. When requesting the event from the distribution server 300, the relay server 200 uses the authentication information which is recorded in association with the individual ID information on the camera 100.

Next, in step S604, the distribution server 300 transmits the event to the relay server 200 in response to the request in step S603. Here, for example, the distribution server 300 transmits a default event (a distribution URL and a stream key which are preset in the requested event) to the relay server 200. At this time, the distribution server 300 appends, to the event, the individual ID information on the camera 100 which has been associated with the authentication information from the relay server 200. In this step, the distribution server 300 also enters a state in which it can receive distribution data from the camera 100.

Next, in step S605, the relay server 200 determines the event received from the distribution server 300. Here, the relay server 200 determines whether the individual ID information on the camera, which is appended to the event received from the distribution server 300, matches the individual ID information on the camera 100 in the registered event information illustrated in FIG. 4B.

The relay server 200 may determine the event without transmitting the individual ID information on the camera to the distribution server 300, by using a pre-registered user ID and password. In this case, the relay server 200 may determine whether a registered distribution URL matches a distribution URL transmitted from the distribution server 300.

Next, in step S606, the relay server 200, based on a determination result that the

individual ID information on the camera appended to the event matches the individual ID information on the camera 100, transmits the event received in step S604 to the camera 100 which is registered in association with the event (livestreaming). At this time, the relay server 200 transmits a transmission URL and a stream key included in the event received in step S604 to the camera 100. Accordingly, when the event is received from the distribution server 300 in a case where multiple cameras are registered in the relay server 200 as illustrated in FIGS. 4A and 4B, the relay server 200 selects the camera associated with the event and transmits the event to the camera. That is, the event corresponding to each camera is distributed and transmitted.

In other words, even when multiple livestreaming sessions scheduled for the same

date and time and associated with different cameras are registered in the database, the relay server 200 transmits the event received from the distribution server 300 to the camera which is registered in association with the livestreaming executed by the event. The relay server 200 does not transmit the event to the other cameras.

In this embodiment, the case has been described in which the relay server 200 transmits the individual ID information on the camera to the distribution server 300, appended to the authentication information. However, in a case where the relay server 200 can determine, in step S605, the camera registered in association with the event received from the distribution server 300, it is not necessary to transmit the individual ID information on the camera to the distribution server 300.

Next, in step S607, the camera 100 displays a standby screen illustrated in FIG. 7B on the display unit 106 before transmitting the distribution data to the distribution server 300. The camera 100 displays a live-view image on the display unit 106, and also displays a Live Start switch 703. The user can prepare for the livestreaming by adjusting the angle of view and the like while referring to the live-view image.

Thus, the camera 100, having received the event from the distribution server 300 via the relay server 200, performs the livestreaming of the distribution data directly to the distribution server 300 by subsequent processing.

In step S608, the camera 100 accepts input of a livestreaming start instruction by a user operation of the Live Start switch 703. The camera 100 transmits, as the distribution data, image data generated by imaging after this step and audio data acquired after this step to the distribution server 300.

Next, in step S609, the camera 100 transmits the distribution data to the distribution server 300 using the transmission URL and the stream key received from the relay server 200 in step S606. The camera 100 repeats the processing of this step until the livestreaming start instruction is given. In this manner, by continuously transmitting the distribution data to the distribution server 300, the camera 100 can perform the livestreaming via the distribution server 300.

The distribution server 300 distributes the received distribution data to viewers. FIG. 7C illustrates an example of a display screen on the display unit 106 of the camera 100 during the livestreaming. This display screen illustrates “•Live” indicating that the livestreaming is in progress, information 704 on the livestreaming received by the camera 100 from the distribution server 300, and a Live Stop switch 705. Here, the information 704 on the livestreaming includes the number of viewers currently watching. As other examples of the information 704 on the livestreaming, a communication status with the distribution server 300, numerical values indicating an evaluation of the livestreaming, and comments received from viewers during the livestreaming may also be displayed. The camera 100 receives the information 704 on the livestreaming from the distribution server 300 as needed during the livestreaming.

The relay server 200 may also transmit, to the distribution server 300, image data among the distribution data received from the camera 100, which has been processed or modified by image processing. For example, when a person who has not granted permission for imaging or distribution of image data is included in a case of livestreaming an event in which many participants are present, the privacy of such individual (a specific object) may be protected by reducing the resolution of that person's image. Additionally, in a sports event, processing such as adding text or symbols to the image data to be distributed may be performed to display a team name, score, and the like.

In step S610, the camera 100 accepts input of a livestreaming end instruction by a user operation of the Live Stop switch 705.

Next, in step S611, the camera 100 terminates recording of the image data by imaging and terminates the livestreaming.

Next, in step S612, the camera 100 transmits a request for terminating the livestreaming to the relay server 200.

Next, in step S613, the relay server 200 requests the distribution server 300 to terminate the livestreaming, based on the request received in step S612.

Next, in step S614, the distribution server 300 transmits, to the relay server 200, a notification indicating that the livestreaming has been terminated, in response to the request received in step S613.

Next, in step S615, the relay server 200 transmits, to the camera 100, a notification indicating that the livestreaming has been terminated, based on the notification received in step S614. Through the above processing, the livestreaming from the camera 100 is terminated.

In this manner, in a case where the camera 100 can use the communication protocol of the distribution server 300, the camera 100 can perform the livestreaming by directly transmitting the distribution data to the distribution server 300.

### Processing of Camera 100

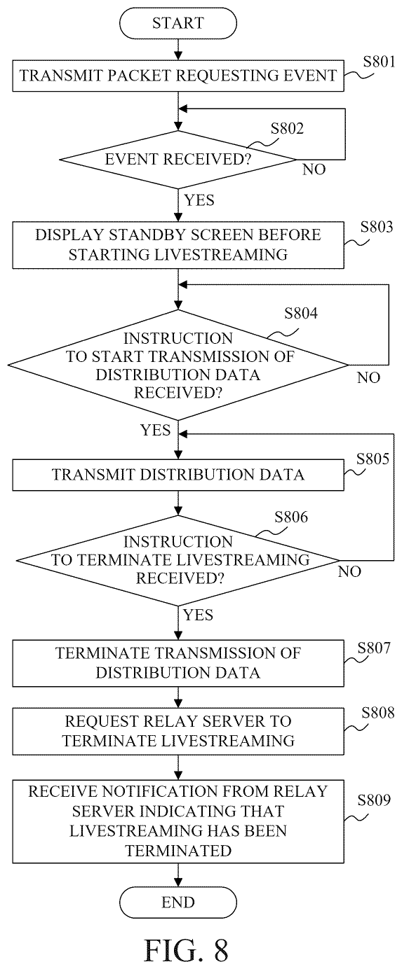

A flowchart in FIG. 8 illustrates processing executed by the control unit 101 of the camera 100 in livestreaming processing. The control unit 101 executes this processing in accordance with a program stored in the nonvolatile memory 103 and developed in the working memory 104. The control unit 101 starts this processing in response to acceptance of the livestreaming start instruction via the user operation of the Live switch 702 illustrated in FIG. 7A (step S601 in FIG. 6).

Next, in step S801, the control unit 101 transmits a packet requesting the event to the relay server 200 via the connector 111. This step corresponds to step S602 in FIG. 6.

Next, in step S802, the control unit 101 determines whether the event has been received from the relay server 200 via the connector 111. After receiving the event, the control unit 101 holds the received event in the working memory 104 and performs the processing of the next step S803. The control unit 101 repeats this processing until the event is received. This step corresponds to step S606 in FIG. 6.

In step S803, the control unit 101 displays the standby screen illustrated in FIG. 7B on the display unit 106. This step corresponds to step S607 in FIG. 6.

Next, in step S804, the control unit 101 determines whether input of the livestreaming start instruction by the user operation of the Live Start switch 703 has been accepted. After accepting the input of the livestreaming start instruction, the control unit 101 performs the processing of step S805. The control unit 101 repeats this processing until the input of the livestreaming start instruction is accepted. This step corresponds to step S608 in FIG. 6.

In step S805, the control unit 101 transmits the distribution data to the distribution server 300 via the connector 111, based on the event received in step S802. The distribution data is image data and audio data which are respectively generated and acquired after step S805. The control unit 101 holds the distribution data in the working memory 104, and when a predetermined amount of distribution data is stored in the working memory 104, the control unit 101 transmits the stored distribution data to the distribution server 300 via the connector 111. As illustrated in FIG. 7C, the control unit 101 displays, on the display unit 106, the live-view image, “•Live” indicating that the livestreaming is in progress, and the information 704 on the livestreaming. The control unit 101 also displays the Live Stop switch 705 on the display unit 106. The control unit 101 continues transmission of the distribution data until input of the livestreaming end instruction is accepted. This step corresponds to step S609 in FIG. 6.

Next, in step S806, the control unit 101 determines whether the input of the livestreaming end instruction by the user operation of the Live Stop switch 705 has been accepted. After accepting the input of the livestreaming end instruction, the control unit 101 performs the processing of step S807. On the other hand, in a case where the input of the livestreaming end instruction has not been accepted, the control unit 101 continues the livestreaming in step S805. This step corresponds to step S610 in FIG. 6.

In step S807, the control unit 101 terminates the transmission of the distribution data. This step corresponds to step S611 in FIG. 6.

Next, in step S808, the control unit 101 requests the relay server 200 to terminate the processing of the livestreaming. This step corresponds to step S612 in FIG. 6.

Next, in step S809, the control unit 101 receives the notification from the relay server 200 indicating that the processing of the livestreaming has been terminated, and ends this processing. In a case where this notification is not received after a predetermined time has elapsed, the control unit 101 executes the processing of step S808 again. This step corresponds to step S615 in FIG. 6.

### Processing of Relay Server 200

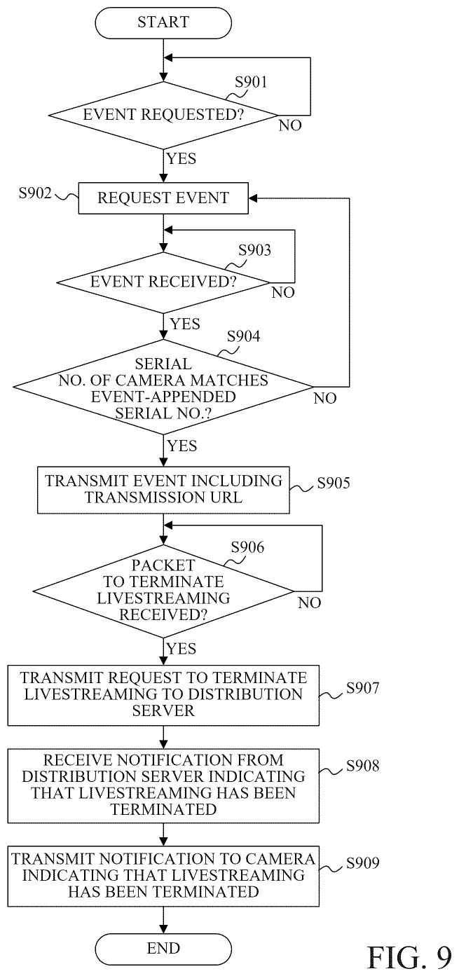

A flowchart in FIG. 9 illustrates an information processing method executed by the control unit 201 of the relay server 200 in livestreaming processing. The control unit 201 executes this processing in accordance with a program stored in the nonvolatile memory 203 and developed in the working memory 204.

In step S901, the control unit 201 determines whether the packet requesting the event has been received from the camera 100. After receiving this request packet, the control unit 201 performs the processing of step S902. The control unit 201 repeats the processing of this step until the request packet is received. However, in a case where the request packet is not received even after a predetermined time has elapsed, the control unit 201 may terminate this processing. This step corresponds to step S602 in FIG. 6.

In step S902, the control unit 201 transmits the packet requesting the event to the distribution server 300 via the connector 211. At this time, the control unit 201 requests the event from the distribution server 300 using the authentication information. This step corresponds to step S603 in FIG. 6.

In step S903, the control unit 201 determines whether the event has been received from the distribution server 300 via the connector 211. After receiving the event, the control unit 201 performs the processing of step S904. The control unit 201 repeats the processing of this step until the event is received. However, in a case where the event is not received even after a predetermined time has elapsed, the control unit 201 may request the event from the camera 100. This step corresponds to step S604 in FIG. 6.

In step S904, the control unit 201 refers to the database illustrated in FIG. 4B to determine whether the serial number of the camera appended to the event received from the distribution server 300 in step S903 matches the serial number of the camera 100. In a case where the serial numbers match, the control unit 201 performs the processing of step S905. On the other hand, in a case where the serial numbers do not match, the control unit 201 requests a new event in step S902. This step corresponds to step S605 in FIG. 6.

In this manner, by determining the serial numbers of the camera 100 and the distribution server 300, the relay server 200 eliminates the need for the camera 100 to perform the processing for determining the event received from the distribution server 300.

In step S905, the control unit 201 transmits the event received from the distribution server 300 to the camera 100. This step corresponds to step S606 in FIG. 6.

Next, in step S906, the control unit 201 determines whether the packet requesting the termination of the livestreaming has been received from the camera 100. The control unit 201 repeats the processing of this step until the request packet is received. After receiving the request packet of the termination of the livestreaming, the control unit 201 performs the processing of step S907. This step corresponds to step S612 in FIG. 6.

In step S907, the control unit 201 transmits the packet requesting the termination of the livestreaming to the distribution server 300. This step corresponds to step S614 in FIG. 6.

Next, in step S908, the control unit 201 receives the notification from the distribution server 300 indicating that the livestreaming has been terminated. This step corresponds to step S613 in FIG. 6.

Next, in step S909, the control unit 201 transmits the notification indicating that the livestreaming has been terminated to the camera 100. This step corresponds to step S615 in FIG. 6.

In this manner, the relay server 200 determines the event registered in the camera

100 and the distribution server 300. Accordingly, regardless of the number of events managed by the distribution server 300, the user can perform the livestreaming at a desired date and time through the camera 100.

According to this embodiment, the user can perform the livestreaming using the network distribution service without performing complicated settings on the camera 100.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to this disclosure, the user can distribute the distribution data using the network distribution service without performing complicated settings on the image pickup apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An information processing apparatus that is used when distribution data generated by an image pickup apparatus is distributed via a distribution server of a network distribution service, the information processing comprising:
one or more memories storing instructions; and
one or more processors that, upon execution of the instructions, operate to:
acquire first information for registering the image pickup apparatus and second information for registering distribution of the distribution data,
register the image pickup apparatus in association with the distribution,
transmit the second information to the distribution server,
receive third information for executing the distribution created by the distribution server based on the second information, and
transmit the third information to the image pickup apparatus registered in association with the distribution executed using the third information,
wherein the second information includes a date and time of the distribution.

2. The information processing apparatus according to claim 1, wherein in a case where a plurality of distributions having the same date and time and associated with different image pickup apparatuses are registered by the one or more processors, the one or more processors operate to transmit the third information to the image pickup apparatus registered in association with the distribution executed using the third information, and not to transmit the third information to the other image pickup apparatuses.

3. The information processing apparatus according to claim 1, wherein the one or more processors operate to:
transmit the first information to the distribution server in addition to the second information, and
receive the third information to which the first information is appended from the distribution server.

4. The information processing apparatus according to claim 1, wherein the first information includes individual ID information on the image pickup apparatus.

5. The information processing apparatus according to claim 1, wherein the one or more processors operate to acquire the first information and the second information from the image pickup apparatus or from a communication apparatus which is capable of communicating with the information processing apparatus.

6. The information processing apparatus according to claim 1, wherein the third information includes an address to which the distribution data is to be transmitted and a stream key.

7. The information processing apparatus according to claim 1, wherein the one or more processors operate to perform image processing for reducing a resolution of a specific object in image data included in the distribution data.

8. The information processing apparatus according to claim 1, wherein the network distribution service is a cloud service using streaming technology.

9. The information processing apparatus according to claim 1, wherein the network distribution service is a livestreaming service.

10. An image pickup apparatus configured to:
acquire the third information from the information processing apparatus according to claim 1, and
execute the distribution using the third information.

11. A distribution system comprising:
the information processing apparatus according to claim 1; and
the distribution server,
wherein the image pickup apparatus executes the distribution using the third information.

12. An information processing method for distributing distribution data generated by an image pickup apparatus via a distribution server of a network distribution service, the method comprising:
acquiring first information for registering the image pickup apparatus and second information for registering distribution of the distribution data;
registering the image pickup apparatus in association with the distribution;
transmitting the second information to the distribution server;
receiving third information for executing the distribution created by the distribution server based on the second information; and
transmitting the third information to the image pickup apparatus registered in association with the distribution executed using the third information,
wherein the second information includes a date and time of the distribution.

13. A non-transitory computer-readable storage medium for storing a program which causes a computer to execute the information processing method according to claim 12.
